(19) United States
(12) Patent Application Publication
(10) Pub. No.: US 2026/0061415 A1
(43) Pub. Date: Mar. 5, 2026

(54) PIPETTING AID WITH STEPLESS OPERATION

(71) Applicant: INTEGRA Biosciences AG, Zizers (CH)

(72) Inventors: Christoph Philipp, Bad Ragaz (CH); Philipp Schatzer, Mels (CH); Andreas Gross, Chur (CH); Jonas Goldowsky, Ebikon (CH); Noa Schmid, Alpnachstad (CH)

(21) Appl. No.: 19/315,504

(22) Filed: Aug. 30, 2025

(30) Foreign Application Priority Data
Sep. 2, 2024 (CH) 000935/2024

(51) Int. Cl. B01L 3/02

(52) U.S. Cl. CPC B01L 3/0227; B01L 2200/02; B01L 2300/0663; B01L 2300/123; B01L 2400/0487; B01L 2400/0622

(57) ABSTRACT

A pipetting device for holding a pipette is shown and described, wherein the pipette is intended for the aspiration and dispensing of a liquid. The pipetting device includes a receiving device for a pipette, a pump with a steplessly configurable pump output, and at least one valve for controlling the pumping direction in such a way that the pump generates positive pressure or negative pressure in the receiving device during operation, depending on the position of the valve. Furthermore, the pipetting device includes at least one actuator button for switching on the pump and for controlling the valve. The pipetting device is characterized in that the pipetting device has a sensor arrangement for detecting a gas flow in the conduit, wherein a pump output of the pump is steplessly regulated by an actuator button signal generated by variable actuator button pressure and the detection of the gas flow.

### CROSS-REFERENCE TO RELATED APPLICATIONS

This application claims priority to Swiss Patent Application No. CH000935/2024 filed Sep. 2, 2024, the disclosure of this application is expressly incorporated herein by reference in its entirety.

### TECHNICAL FIELD OF THE INVENTION

The invention relates to a pipetting aid.

### BACKGROUND OF THE INVENTION

The pipetting aid is a laboratory device that simplifies the dosing of liquids using a pipette. The pipette has an upper and a lower opening. When pipetting, a specific amount of liquid is first aspirated and then dispensed either as a whole or in smaller doses. The volume flow through the lower opening of the pipette is controlled by the volume flow of air at its upper opening. The volume removed from the upper opening of the pipette must be introduced through its lower opening, and vice versa. This applies when air is drawn in or expelled. However, when moving a liquid, such as water, the air volume required to correspond exactly to a specific aspirated or dispensed liquid volume is subject to various physical laws that influence the volume (temperature, negative/positive pressure, density of the liquid, etc.).

When using a pipetting aid, it is connected to the upper opening of the pipette. The pipetting aid determines the volume flow at the upper opening and thus also controls the volume flow at the lower opening. This applies to both liquid intake (aspiration) and liquid output (dispensation). Motorized pipetting aids have a pump that is usually activated by pressing a button on the pipetting aid. The pump creates negative pressure when liquid is to be drawn in, i.e., when the pipette is to be filled with a specific volume. During aspiration, air is drawn in through the upper opening of the pipette, causing liquid to flow into the pipette when the pipette tip is immersed in a liquid. The pump can also be used to generate positive pressure in the connecting conduit during dispensing.

A membrane pump is usually used as the pump. This is designed in such a way that it can call up a predetermined mechanical pump output and optionally allows this mechanical output to be changed via a configuring device.

Apart from the use of a configuring device, the pump therefore has only two operating states, namely “off” or “pumping.” A simple on/off switch can be used for this purpose. One disadvantage of using such a pump is that the pipetting aid has a minimum pump output that cannot be exceeded. This means that during aspiration, the volume flow cannot increase continuously from zero without the aid of needle valves or similar mechanical flow regulators but instead jumps to a minimum volume flow after the pump is started. This is referred to as a stepped pump. In order to enable stepless operation of such a pump, it is known to combine the stepped pump with a steplessly configurable valve. However, this is costly because additional mechanical components are required, which also need to be controlled.

### Task

It is therefore an object of the present invention to provide an improved pipetting aid which enables uniform and thus stepless aspiration and dispensing without the need for a stepless valve. Another objective of the invention is to provide a pipetting aid that allows a user-set volume to be dispensed accurately and repetitively, thereby enabling the user to perform repetitive dispensing of liquid more quickly, easily, and precisely. Another objective of the invention is to prevent overfilling of a pipette with a known volume in order to avoid damage to the device or time-consuming cleaning of the pipetting aid.

### Description

The solution to the task set is achieved in a pipetting aid by the features listed in the independent claim. Further developments and/or advantageous design variants are the subject of the dependent patent claims.

The invention relates to a pipetting aid for receiving a pipette, wherein the pipette is intended for the aspiration and dispensing of a liquid. The pipetting aid comprises a receiving device for receiving a pipette, a pump with a stepless operating curve, and at least one valve for controlling the pumping direction in such a way that, during operation, the pump generates positive pressure or negative pressure in the pipetting aid depending on the position of the valve. Furthermore, the pipetting aid comprises a conduit between the receiving device and the pump, and at least one actuator button for operating the pump and controlling the valve. For example, the actuator button is designed in conjunction with a sensor to generate an actuator button signal that can assume a variety of values between zero and a specific maximum level, wherein the control unit controls the pump output depending on the respective value assumed by the actuator button signal.

Pressing the actuator button activates the pump and opens or closes the valve. The pump output is steplessly regulated by pressing the actuator button to a variable degree. The valve adjusts the pumping direction of the pump. The pumping direction determines whether the pump creates positive or negative pressure in the pipetting aid. The negative or positive pressure generated by the pump is transmitted via the conduit to the receiving device and a pipette received in the receiving device. The resulting pressure difference at the upper and lower ends of the pipette thus leads to the intake or discharge of a liquid into or out of the pipette. Negative pressure causes a liquid to be received, while positive pressure causes the liquid to be dispensed from the pipette. It goes without saying that during aspiration, the front end of the pipette must be immersed in the liquid to be aspirated, and that during dispensing, the pipette tip must be placed over a container that is designed to receive a specific amount of the dispensed liquid.

For example, the actuator button is connected to a pressure-sensitive sensor, and the actuator button signal changes with the amount of pressure applied. This is a simple arrangement that can be implemented, for example, with the aid of a strain gauge. The use of a strain gauge has the advantage that its electrical resistance changes proportionally to the mechanical strain acting on it. This change in resistance can be measured using a Wheatstone bridge circuit, which is normally supplied with a constant direct current (DC) voltage. Accordingly, the output signal of a strain gauge is primarily a direct current (DC) signal whose level or voltage changes with the mechanical load.

For example, the actuator button is movable and, in conjunction with the sensor, generates an actuator button signal whose value varies depending on the button stroke or movement path. In conjunction with a spring, the button stroke can exert a variable force on a pressure-sensitive sensor, e.g., a strain gauge.

According to a preferred embodiment of the invention, the actuator button signal is an analog signal, e.g., generated by a pressure-sensitive sensor, and the pump output of the pump is coupled to the level of the analog signal. The greater the movement path of the actuator button, the greater the level of the analog signal. The analog signal is then transmitted directly or indirectly to the pump via a processor built into the pipetting aid.

The actuator button is advantageously preloaded into the rest position by a compression spring. This has the advantage that the user experiences haptic feedback (or tactile feedback) through progressive resistance. In the case of the spring-loaded actuator button, the user feels a change in resistance, which provides a direct sense of interaction.

According to a preferred embodiment of the invention, the compression spring is supported on a flexible shaft. This can be part of a printed circuit board. The flexible shaft can be made by cutting a U-shaped tab or tongue out of the circuit board. The strain gauge is attached to the circuit board at the point where the flexible shaft bends, e.g., by means of a solder or adhesive connection.

The pipetting device has a sensor arrangement that is configured to detect a gas flow in the conduit, wherein the pipetting device is also configured to steplessly regulate the pump output of the pump by means of an actuator button signal generated by variable pressure on the actuator button and the detection of the gas flow.

In one embodiment, the conduit between the receiving device and the pump is connected to a bypass conduit, and the sensor arrangement is configured to provide detection of the gas flow in the conduit by detecting a gas flow in the bypass conduit. For example, gas flow in the bypass conduit is linked to the level of the (e.g., analog) actuator button signal.

The bypass conduit is an additional, e.g. narrower, path that is disconnected from the actual conduit and reconnected in the conduit downstream of the conduit.

In one embodiment, the pipetting aid has a gas flow sensor in the conduit between the receiving device and the pump, and the mass or volume flow in this conduit is coupled via the control unit to the level of the actuator button signal. This has the advantage that the pump output can be steplessly regulated by variable button pressure and depending on the measured mass or volume flow in the conduit. The mass or volume flow can be displayed on a screen, for example, as a bar whose size changes depending on the mass or volume flow.

In one embodiment, the sensor arrangement is designed based on a differential pressure principle, wherein part of the gas is routed through the bypass and the gas flow in the bypass is detected or measured using a thermal measuring principle. In the thermal measurement principle, two temperature sensors detect the temperature difference before and after a heated element. The gas flow is then detected based on the fact that the change in this difference correlates directly with the gas flow.

In a further embodiment, the sensor arrangement is designed based on a differential pressure principle, wherein the gas flow is detected based on the fact that the volume flow is proportional to a pressure difference generated via a defined constriction (e.g., orifice plate, Venturi nozzle).

In a further embodiment, the sensor arrangement is designed based on an ultrasonic principle, wherein ultrasonic waves are transmitted against and with the direction of flow, wherein the gas flow is detected based on a time difference of the ultrasonic waves, which provides conclusions about the flow velocity.

In a further embodiment, the sensor arrangement is designed based on the Coriolis principle (for mass flow), wherein the gas flow is detected based on the fact that a deformation of a pipe caused by flow can be used to directly detect the mass flow.

It goes without saying that the sensor arrangement can also be designed based on a combination of the above-mentioned measuring principles.

For example, a thermal gas/mass flow sensor of the SDP type from Sensirion could be used. Due to its small size, such a sensor can be arranged directly behind the filter and in front of the valves, wherein the sensor can be connected directly to the microprocessor and the power supply.

In principle, the types of gas flow sensors described below could also be used, although in their current designs they tend to provide measurements of differences in gas flow that are too “rough” (for applications of a pipetting aid as described in the invention): A gas flow sensor for direct volume measurement, e.g., a meter with a constant measuring chamber volume (such as a drum meter), a meter with a variable measuring chamber volume, or an oval wheel meter. Alternatively, or in addition, an indirect volume meter could be used, e.g., a magnetic-inductive flow meter.

For example, the value of the signal transmitted to the pump determines the operating point or pump output. Linking the button stroke of the actuator button to the pump's operating point allows the user to aspirate and dispense liquid steplessly between 0% and 100% pump output. At the same time, the dispensing and aspiration behavior can be determined by the pump. The magnitude of the positive pressure or negative pressure determines the volume flow into or out of the pipette and thus the flow rate of the liquid to be aspirated or dispensed. This gives the user a better feel when operating the pipetting device, as the movement of the actuator button has a direct effect on the volume flow of the liquid. In the prior art, it is known to achieve stepless operation of the pump, for example, by combining a stepped pump with a steplessly configurable valve and, optionally, with a pneumatic damper.

However, the use of a steplessly configurable pump, i.e., a pump with steplessly variable pump output, has the advantage that a liquid with a minimum volume flow can be aspirated or dispensed using a pipetting aid according to the invention, wherein, in contrast to the designs commonly used today, the volume flow is not abruptly reduced to zero.

In one embodiment, the pipetting aid has a gas flow sensor on the conduit between the receiving device and the pump, and the gas flow in this conduit is coupled to the level of the analog signal. The gas flow sensor measures the volume or mass flow of the gas mixture in the conduit. This volume or mass flow depends on the pressure difference generated by the pump. This allows the gas flow to be configured by controlling the pump. The user can use the movable actuator button to determine the operating point of the pump and thus the volume flow of the liquid to be aspirated or dispensed. The level or value of the signal generated by the pressure-sensitive sensor determines the volume flow rate.

Alternatively, the gas flow can be measured either by mass flow or volume flow measurement. The processor can be used to convert the measured values, taking into account various parameters such as pressure and temperature and, optionally, humidity, etc. Alternatively, the measured values can be obtained in already converted form from a suitably designed sensor.

Advantageously, the control unit has a microprocessor and a memory in which a program is stored that converts the analog sensor signal into a digital signal. When converting the analog signal into a digital signal, it is important that no information from the analog signal is lost. Converting the signal to digital format has the advantage that it can be transmitted and processed more easily and fed to other devices, such as a pump. However, it is also conceivable to control the pump with an analog signal. However, digital signals have the advantage of being less susceptible to interference and easier to manipulate.

The program is preferably designed to convert the signal in such a way that the transfer function is linear to the pump output. A linear transfer function has the advantage of establishing a directly proportional relationship between the button stroke of the actuator button and the volume flow delivered by the pump.

In an alternative embodiment, however, it is conceivable that the program is designed to convert the signal in such a way that the transfer function to the pump output is non-linear, in particular exponential. A non-linear transfer function can be used to increase the sensitivity of the pump operation to the button stroke of the actuator button. An exponential transfer function enables an almost linear relationship between the button stroke of the actuator button and the mass or volume flow delivered by the pump at a small button stroke, wherein this relationship changes with increasing button stroke, so that a greater mass or volume flow is delivered for a given movement path of the actuator button than with a linear transfer function. This means that a small change in the stroke of the actuator button causes a significant change in the mass or volume flow when the mass or volume flow is high, and better control can be achieved with low mass or volume flows, as larger movements have less of an effect.

Preferably, the pipetting aid comprises a handle, and the actuator button(s) is/are arranged on the handle. The arrangement of the actuator button on the handle allows a user to retain the pipetting aid with one hand while simultaneously dispensing or aspirating a liquid. This means that you do not need to use your other hand or change the position of your hand while retaining the pipetting aid. The handle is preferably ergonomically shaped so that a user can retain and operate the pipetting aid with one hand on the handle.

In a preferred embodiment, the actuator button is preloaded to the rest position by a compression spring. To press the actuator button, the user must move it against the force of the compression spring. This provides the user with tactile feedback on the movement path of the actuator button when the actuator button is used, when the contact pressure increases with increasing movement path. Preferably, the operating point of the pump is determined by the spring force of the compression spring of the actuator button.

The pump is advantageously a membrane pump. The membrane pump is suitable for use in the pipetting aid according to the invention due to its high reliability.

Preferably, the pump for generating negative or positive pressure is a piezoelectric pump. The use of a piezoelectric pump has the advantage of enabling stepless operation, among other things, which is a major advantage for use in a pipetting aid. In addition, a piezoelectric pump is small and lightweight, making it particularly well suited for use in a portable pipetting aid. The piezoelectric pump is quiet during operation, which in turn increases comfort when working with a pipetting aid that features a piezoelectric pump.

A piezoelectric pump is a micromembrane pump that uses disc-shaped piezo actuators. The mechanical properties of piezoelectricity are used to move liquids or gases. The general structure of a piezoelectric micromembrane pump is as follows: One or more disc-shaped piezo actuators are attached to a flexible membrane. This piezo actuator serves as the pump's drive element. The membrane is often made of an elastic material that can bend or deform. Optional inlet and outlet valves control the flow of the medium into and out of the pump chamber. Double-acting piezoelectric membrane pumps have two pump chambers instead of just one.

In another preferred embodiment, the pipetting aid has a second actuator button which generates a second actuator button signal depending on the button stroke, wherein the first actuator button signal of the first actuator button causes a negative pressure, and the second actuator button signal of the second actuator button causes a positive pressure in the pipetting device. For example, pressing the first actuator button activates the aspiration mode, and pressing the second actuator button initiates the dispensing of the liquid.

The two signals from the actuator buttons can be used to control one or more valves, which are used to configure the pumping direction and, depending on the position of the valve when the pump is in operation, either increase or reduce the pressure in the pipetting aid. Among other things, two 3/2-way valves (three connections, two positions) can be arranged as valves, but a 5/3-way valve (5 connections, three positions) is also conceivable. The user can control the operation of the pump in both directions with the aid of the button stroke of the actuator buttons.

The pipetting aid preferably has a third actuator button that can be used to activate a switch which causes a predetermined amount of liquid (aliquot) to be dispensed or releases the negative pressure in the pipetting aid so that the entire amount of liquid is dispensed. When the third actuator button is pressed, a digital signal can be generated which causes the negative pressure to be released or positive pressure to be generated in the pipetting device, wherein the release of the negative pressure in the pipetting device is temporary and the negative pressure is re-generated after a predefined period of time or after a predefined volume or mass has flowed through.

Alternatively, pressing the third actuator button can generate a digital signal that causes an increase in the negative pressure in the pipetting device, wherein the increase in the negative pressure in the pipetting device is temporary and the original negative pressure is restored after a predefined period of time or after a predefined volume or mass has flowed through.

The third actuator button can be used to temporarily release the negative pressure, thereby dispensing a precisely measured amount of liquid from the pipette. Either the duration of the negative pressure release determines the volume of liquid dispensed, or the volume of liquid to be dispensed determines the duration of the negative pressure release. To determine the amount of liquid to be dispensed, the gas flow in the conduit between the receiving device and the pump is measured and regulated. The dispensing volume can be configured by varying a predefined time period. If the amount of liquid to be dispensed is known, the duration of the interruption of the negative pressure can be made dependent on this amount. After dispensing the desired quantity, the negative pressure is released, and dispensing is stopped when the negative pressure is restored.

Unlike the first two actuator buttons, the third actuator button is preferably not coupled with the button stroke. This means that the command to release negative pressure or generate positive pressure is given by simply pressing the third actuator button. This effect can be repeated as often as desired by pressing the button repeatedly, thereby achieving, for example, the repetitive dispensing of a constant amount of liquid. The procedure described above can also be used in analog form to receive a specific amount of liquid.

The provision of a gas flow sensor for measuring the mass or volume flow has the advantage that the amount of liquid to be aspirated or dispensed can be calculated if the prevailing pressure is known. This means that the user is no longer responsible for ensuring that the correct amount of liquid is dispensed; instead, this task can be left to the pipetting device. The only thing the user still has to do is tell the control unit how much liquid should be aspirated or dispensed.

In a further embodiment, the pipetting device has a pressure sensor for measuring the ambient pressure. By determining the prevailing differential pressure, it is possible to calculate and optionally display the current amount of liquid in the pipette. The pressure measured by the pressure sensor is used as an auxiliary value to determine the static situation in the pneumatic system. This allows for an even more accurate determination of the gas flow. In other words, in contrast to the sensor arrangement for detecting gas flow, the pressure sensor signal makes a more static contribution, and, for example, a more static (rather than dynamic) pressure sensor signal is generated during pipetting dispensing or aspiration (compared to the signal from the sensor arrangement for detecting gas flow).

The control system is advantageously connected to an acceleration sensor. With the help of the acceleration sensor, for example, the position of the pipette relative to the vertical can be determined, which in turn can be used to calculate the amount of liquid to be received or dispensed.

As described above, the conduit is connected to a gas flow sensor, which in turn is connected to the control unit. Preferably, the control unit is also connected to a temperature sensor that measures the temperature in the conduit between the pump and the receiving device.

The present invention also relates to a method for operating a pipetting device (which is designed to receive a pipette), in particular for aspirating or dispensing a liquid. In this process, a pump of the pipetting device with steplessly configurable pump output is steplessly regulated by means of variable button pressure on an actuator button and detection of a gas flow in a conduit between a receiving device for receiving the pipette and the pump. For example, the pump output is controlled depending on a signal from a sensor (e.g., pressure-sensitive) connected to the actuator button, wherein the actuator button signal can assume a variety of values depending on the button pressure.

For example, the mass or volume flow is detected or measured in the conduit and the pump output is regulated accordingly.

In a further embodiment, pressure in the conduit (which is measured rather statically in comparison to the dynamically detected gas flow in the conduit) is also measured to regulate the pump output. For example, a static value of a pressure is used as a backup during regulation.

Depending on the measured mass or volume flow and, for example, depending on the measured pressure, the aspirated or dispensed amount of liquid can be calculated. This has the advantage that the user no longer has to rely on visual estimation but can leave this to the pipetting device according to the invention.

According to an advantageous variant of the method, the deviation of the pipette longitudinal axis from the vertical is additionally taken into account when calculating the aspirated or dispensed amount of liquid. This has the advantage that the user no longer has to ensure that the pipette is arranged vertically during dispensing.

It is conceivable to additionally measure the temperature in the conduit. This is advantageous when there are noticeable differences between the ambient temperature and the temperature in the aspiration conduit of the pipetting device.

In order to achieve high pipetting accuracy, the pipetting device with the gas flow sensor should preferably be calibrated in advance using a calibrated external mass or volume flow sensor.

When calculating the amount of liquid aspirated or dispensed, the external pressure and internal pressure are preferably taken into account.

The optional features mentioned can be implemented in any combination, provided they are not mutually exclusive. In particular, where preferred ranges are specified, further preferred ranges result from combinations of the minimums and maximums specified in the ranges.

The invention is described in more detail below with reference to the figures. The following is shown in the images:

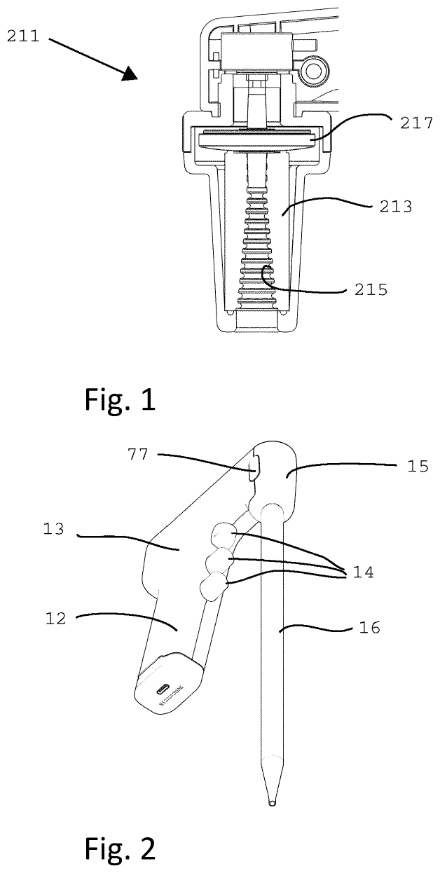

FIG. 1: a cross-section through a receiving device of a pipetting aid of the prior art;

FIG. 2: a perspective view of a pipetting device consisting of a pipetting aid and a first embodiment of a pipette receiving device according to the invention;

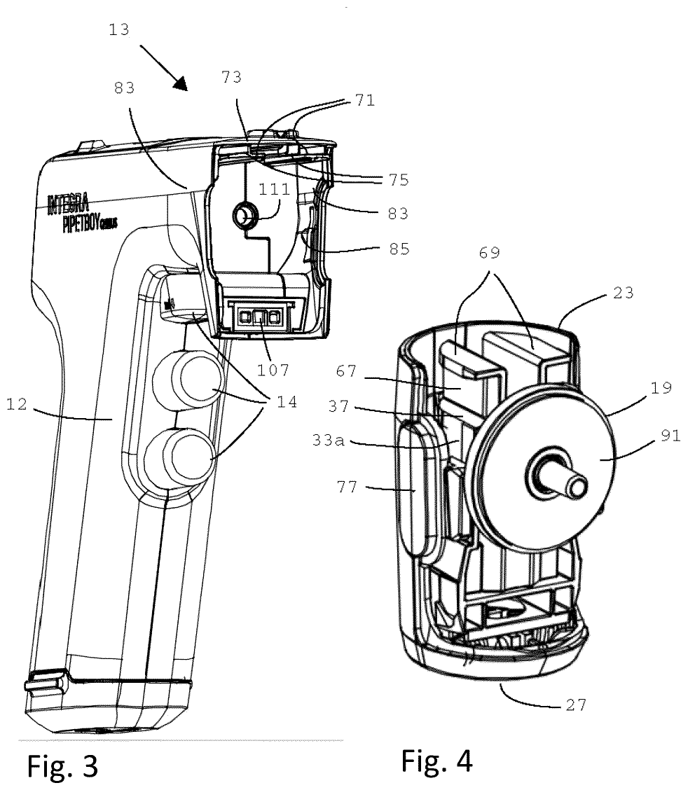

FIG. 3: a perspective view of only the pipetting aid from FIG. 2, in which the pipette receiving device has been removed;

FIG. 4: a perspective view of only the receiving device of FIG. 2 on an enlarged scale and matching the pipetting aid of FIG. 3;

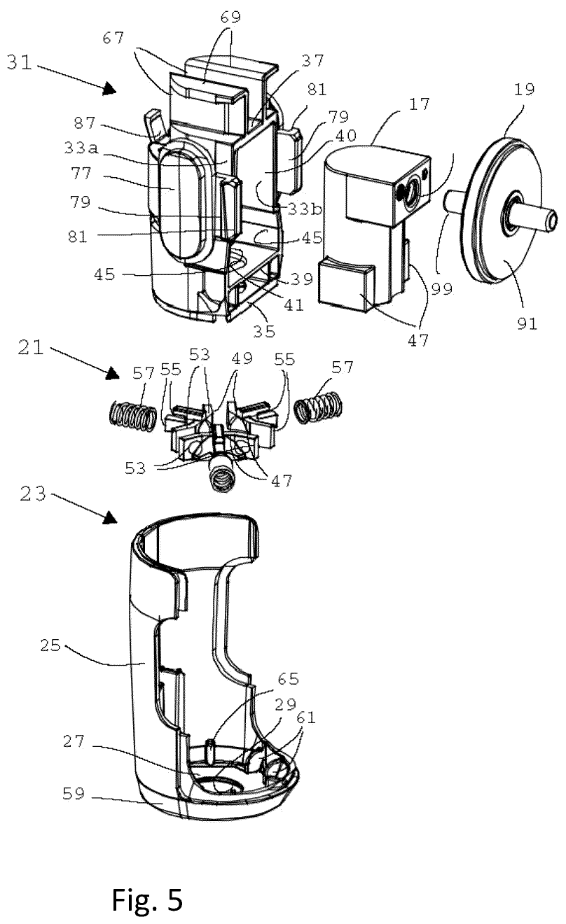

FIG. 5: an exploded view of the receiving device shown in FIG. 4;

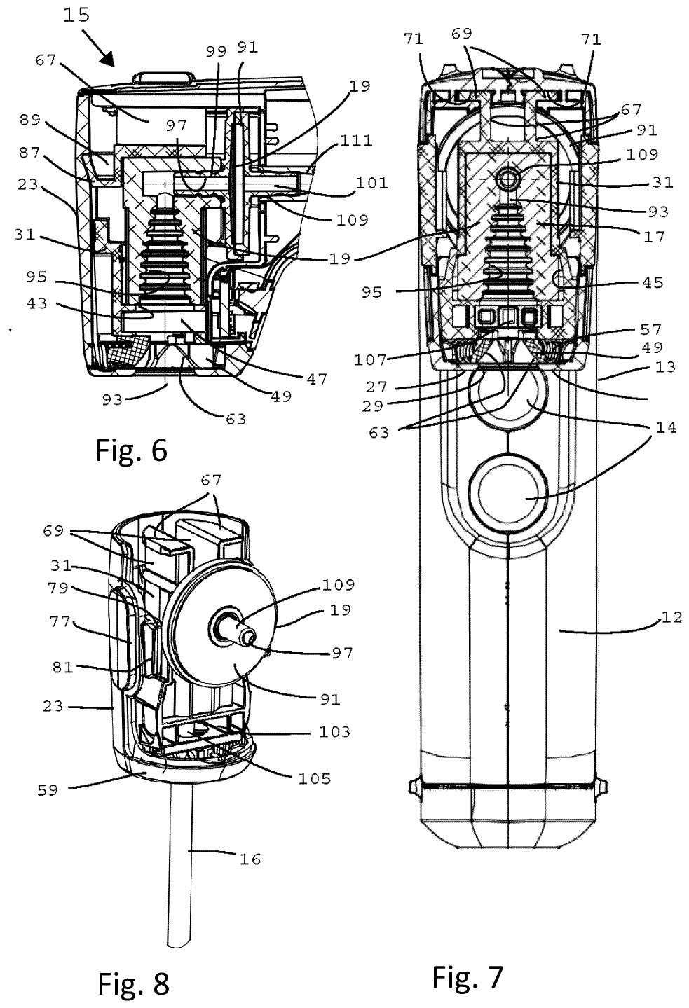

FIG. 6: a longitudinal section through the front part of a pipetting aid with a receiving device;

FIG. 7: a cross-section through the receiving device of FIG. 6 from the front;

FIG. 8: a perspective view of the inventive receiving device with pipette;

FIG. 9: a perspective view of a partially cutaway receiving device with a slightly modified design of the clamping blocks;

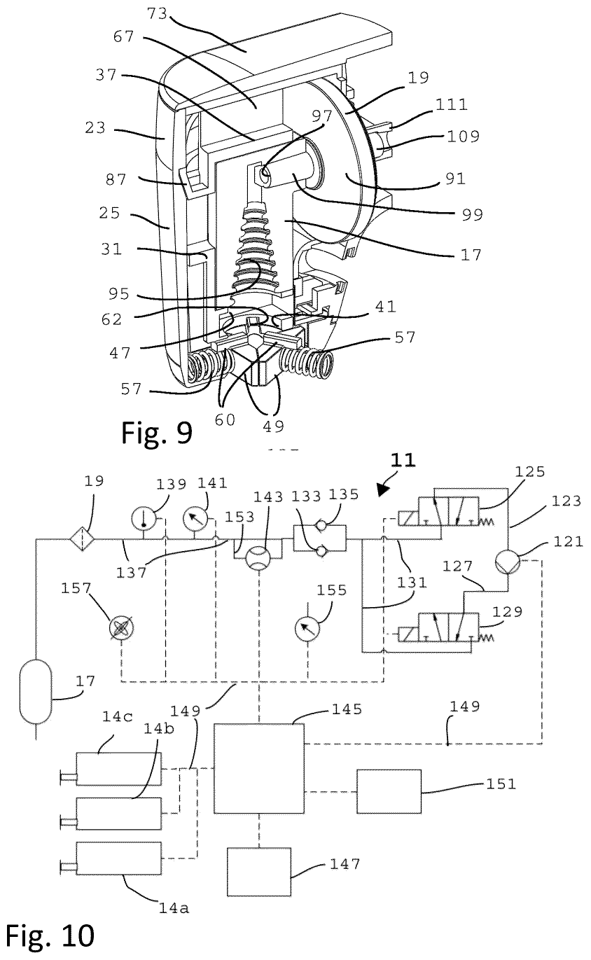

FIG. 10: a schematic representation of the components of the pipetting device, with the valves shown in the aspiration position;

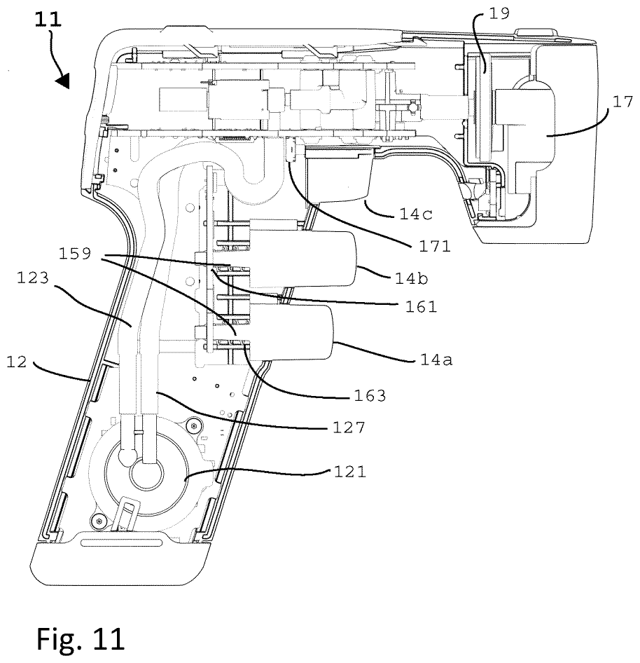

FIG. 11: a side view of the pipetting device with one half of the housing removed; and

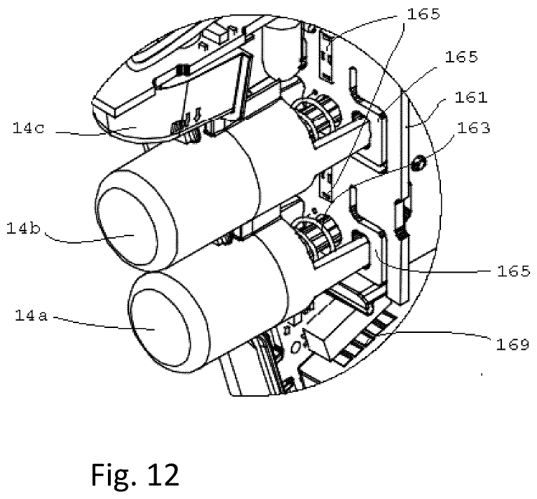

FIG. 12: the device for measuring the contact pressure of the control buttons on a strain gauge.

The receiving device 211 of a pipetting aid according to the current state of the art shown in FIG. 1 has already been described in the introduction to the description. Their main disadvantage is that pipettes received in the pipette holder are not retained securely and can swing back and forth during handling.

The pipetting device 11 shown in FIGS. 2 through 8 consists of a motor-driven pipetting aid 13 and a first embodiment of a pipette receiving device 15 according to the invention. In FIG. 2, a pipette 16 is received in the receiving device 15 for illustrative purposes. The pipetting aid 13 has a handle 12 and control buttons 14, which can be used to control the aspiration or dispensing of a liquid.

The essential components of the inventive receiving device 15 are a pipette holder 17, a filter 19 connected to it, and a clamping device 21, which provides additional support for a pipette received in the pipette holder 17. The aforementioned components of the receiving device 15 are received in housing 23, which comprises a roughly semicircular cylindrical shell 25 and a circular bottom 27 attached to it. The bottom 27 has a central circular opening 29 through which the rear end of a pipette, which in pipettes with larger volumes is a circular cylindrical neck with a tapered diameter, can be introduced into the pipette holder 17.

A headpiece 31, to which the housing 23 can also be attached, serves to receive the pipette holder 17 and at the same time as a connecting means to the pipetting aid 13. The headpiece 31 has a substantially rectangular frame with two side walls 33a, 33b, a bottom wall 35, and a top wall 37. An intermediate bottom wall 39 is located a short distance from the bottom wall 35. Space 41 between top wall 37 and intermediate bottom wall 39 serves to receive the pipette holder 17 precisely. A circular recess 41 is provided in the intermediate bottom wall 39, which may be slightly larger in diameter than the introduction opening 43 of the pipette holder 17 (FIG. 6). The side walls 33a, 33b have rectangular protrusions 45 adjacent to the intermediate bottom wall 39, which protrude outwards at the sides. These serve to receive retaining flanges 47 molded onto the base of the pipette holder 17 and protruding outward. This form-fit connection prevents the pipette holder 17 from slipping when a pipette is tensioned in place.

A novel feature of the described receiving device is that a pipette is retained not only by the pipette holder 17 alone, but also by an additional clamping device 21, which is arranged between the bottom 27 of the housing 23 and the bottom wall 35 of the headpiece 31. In the preferred exemplary embodiment shown, the clamping device 21 comprises three clamping jaws 49, each of which comprises a short straight central piece 51 and two wings 53 extending from the central piece 51 at an angle of approximately 120 degrees. Two parallel webs 55 are provided at the rear of the clamping jaws 53, spaced apart from each other, between which a spring 57 can be placed.

A circumferential, upwardly protruding edge 59 is formed on the periphery of the bottom 27 of the housing 23, from which pairs of spaced-apart, approximately quarter-circular walls 61 protrude in the radial direction, which cooperate with the webs 55 to delimit the clamping jaws 49 and the springs 57 arranged between the webs 55. The springs 57 preload the clamping jaws 49 in the radial direction so that they touch each other in the rest position.

To enable pipettes of different diameters to be introduced and clamped, the clamping jaws 49 feature a slanted surface 63 such that there is a large introduction opening at the bottom and a small outlet opening at the top, wherein the introduction opening can be approximately 10 mm and the outlet opening between 3 and 4 mm. This ensures easy introduction of pipettes without significant resistance and clamping of small-diameter pipettes up to 4 mm.

When assembled, the bottom wall 35 of the headpiece 31 rests on the walls 59 and additional spacers 65, so that there is space between the housing bottom 27 and the bottom wall 35 to receive the clamping device 21.

A latch or snap connection and a form-fit connection are provided for detachable connection of the headpiece 31 to the pipetting aid 13. To achieve the positive connection, two upside-down L-shaped webs are molded onto the top wall 37, with their short legs 69 oriented sideways toward the outside. The legs 69 fit into lateral insertion compartments 71 formed on the housing of the pipetting aid 13. In this case, lateral insertion compartments 71 are located between a housing cover 73 of the pipetting aid and two webs 75, which protrude inward from the inner wall of the housing at a short distance from the housing cover 73. There is a distance between the webs 75 oriented toward each other that is insignificantly greater than the distance between the two angular webs 67 of the headpiece 31.

The latching connection is achieved by two push buttons 77, which are arranged on the outside of the side walls 33a, 33b. The push buttons 77 are connected to L-shaped bolts 79, whose outward-facing legs 81 can engage in undercuts 85 in the pipetting aid, which are provided on the lateral housing walls 83. The push buttons 77 are each preloaded outward by spring means not shown in the figures. It is conceivable that the plastic part itself could be spring-loaded and that the push buttons 77 and the legs 81 could be arranged, for example, on a spring-loaded plastic beam. By pressing the push button, the bolts 79 can be moved inward far enough to release the latching connection between the receiving device 15 and the pipetting aid 13, allowing the pipette receiving device 15 to be removed from the pipetting aid 13.

The cross-sectional views in FIGS. 6 and 7 show the inner workings of the receiving device in greater detail. It can be seen that a hook 87 protruding forward is molded onto headpiece 31, which can form a positive connection with an angular piece 89 provided on the inside of the housing 23 in order to fasten the housing 23 to the headpiece 31.

According to a separate independent aspect of the invention, a compact design of the receiving device 15 is achieved by the fact that the flat filter housing 91 of the filter 19 is no longer arranged perpendicular to a center axis 93 of the receiving device 15, but parallel to it. This is achieved by arranging the pipette receiving channel 95 and the conduit section 97, which serves to receive a connection piece 99 of the filter 19, at a right angle to each other (FIG. 6). This arrangement has the advantage that filter 19 is easily accessible and no part of the housing needs to be unscrewed in order to replace the filter 19. It goes without saying that the conduit section 97 and the connection piece 99 are designed to be slightly conical and/or have sealing lips in order to ensure that filter 19 fits securely in the pipette holder 17 and to guarantee a gas-tight connection between the pipette holder 17 and the filter 19. Alternatively, or additionally, sealing lips can be provided to achieve a good seal.

A gap 103 can be provided between the intermediate bottom wall 39 and the bottom wall 35, where a section of the pipette neck 105 several millimeters long is exposed and visually accessible from the front or from the pipetting aid. A sensor 107 installed in the pipetting aid opposite the gap 103 can thus detect the presence of a pipette 16 marked accordingly on the pipette neck (FIGS. 7 and 8). In combination with a suitable marking on the pipette, e.g., barcode or similar, the pipette type (maximum filling volume) can be determined, for example.

FIG. 6 shows that, when the pipetting device is ready for operation, the second connection piece 109 of the filter housing 91 is inserted into an elastically deformable connecting piece 111 of the pipetting aid.

FIG. 9 shows a slightly modified second embodiment of a clamping device 21. This differs from the clamping device described above in that the clamping jaws 49 have a trapezoidal shape when viewed from above. An elongated guide strip 60 is provided on the upper side of each of the trapezoidal clamping jaws 49, which can interact with a guide groove 62 on the underside of the intermediate bottom wall in order to guide the clamping jaws 49 in the radial direction.

FIG. 10 shows a schematic representation of the components of a pipetting device. In the figure shown, the pneumatic conduits are represented by solid lines and the electrical conduits by dashed lines. The pipetting device 11 has a pump 121 which is connected on one side via a conduit 123 to a multi-way valve 125 and on the other side via a conduit 127 to a multi-way valve 129. The multi-way valves 125, 127 are connected to each other and also to two one-way valves 133, 135 via a conduit 131. It is conceivable that the two functions are combined in a single component. A conduit 137 leads from the one-way valves via filter 19 to the pipette holder 17. The one-way valve 135 opens automatically when air is sucked in, i.e., aspirated, and the one-way valve 133 opens when liquid is delivered, i.e. dispensed. FIG. 10 shows the multi-way valves 125, 129 in the aspiration position, i.e., the multi-way valve 125 is open and the multi-way valve 129 is closed, so that air is sucked in via the conduits 123, 131, and 137.

Sensors for measuring the physical properties of the air flowing through the conduit are installed in conduit 137. The sensors may be, for example, a temperature sensor 139, a pressure sensor 141, and a mass flow sensor 143.

A control unit 145 with a memory unit 147 is provided to control the multi-way valves 125, 129 and the pump 121. The control unit 145 is connected via control conduits 149 to the control buttons 14a, 14b, and 14c on the one hand, and to the multi-way valves 125, 129, and the pump 121 on the other. The motor for the pump and the control unit are powered by a rechargeable battery (not shown in the diagram). An interface 151 allows communication with control unit 145. The interface may be, for example, a keyboard, a touch-sensitive display, or a wireless communication link.

As can be seen from the diagram in FIG. 10, the mass sensor 143 does not measure the volume flow directly in conduit 137, but in a bypass conduit 153. The volume flow in the bypass conduit is only a fraction, typically between 1 and 10 percent of the volume flow in conduit 137. This is what makes it possible to incorporate a gas flow sensor into a battery-powered hand pipetting device, as the gas flow sensors currently available for measuring a volume flow of up to several hundred ml/s are simply too large to be integrated into a hand pipetting device.

The bypass conduit can be part of the gas flow sensor, especially when the thermal measurement principle, an ultrasonic sensor, or a Coriolis sensor is used. For example, the bypass conduit is formed by a supply conduit and a discharge conduit with the gas flow sensor in the middle.

When using a measuring system based on differential pressure, the bypass conduit can be replaced by two connections to a differential pressure sensor. No part of the main gas flow flows through the sensor anymore.

In addition to the sensors already described above, the pipetting device 11 also has a second pressure sensor 155 for measuring the ambient pressure and an acceleration sensor 157. If the ambient pressure and the pressure in conduit 137 are known, the pressure difference can be taken into account when calculating the amount of liquid to be aspirated or dispensed using the general gas equation (P·V=n·R·T).

FIG. 11 shows the inner workings of the pipetting device 11 in more detail. The control buttons 14a and 14b are arranged on a printed circuit board 161 by means of base 159. The control buttons 14a and 14b are movable perpendicular to the printed circuit board 161 and are preloaded into the rest position by a spring 163. Spring 163 is supported on a flexible shaft 165, on which a strain gauge 167 is arranged and firmly connected to the printed circuit board 161, e.g., via a solder connection (FIG. 12). The handle 12 also contains a rechargeable battery 169 for powering the electronics.

The pipetting device works as follows: FIG. 10 shows the aspiration position of the pipetting device. In this position, air is drawn in from the surroundings via conduit 123, multi-way valve 125, and conduits 131 and 137, and is delivered back into the surroundings via conduit 127 and multi-way valve 129.

If both multi-way valves 125, 129 are moved to the other position, the pump 121 sucks in ambient air via the multi-way valve 125 and the conduit 123 and transports it via the conduit 127, the multi-way valve 129, the conduit 131, and the one-way valve 133 and the conduit 137 into a pipette 17 received in the pipette holder 17 (dispensation).

The control buttons 14a, 14b, and 14c can be used to perform aspiration (e.g., control button 14a), dispensing (e.g., control button 14b), or the metered delivery of a specific amount of liquid (e.g., control button 14c). Unlike control buttons 14a and 14b, control button 14c is only connected to a simple on/off switch 171. When switch 171 is pressed, an amount of liquid previously entered via the interface or stored in a memory is dispensed.

The built-in sensors (mass or volume flow and pressure sensor and optional temperature sensor) are used to calculate the amount of liquid aspirated. With additional knowledge of the specific gravity of the liquid, the aspirated or dispensed amount of liquid can be precisely calculated and configured. The existing acceleration sensor can also be used to take into account the tilt of the pipette (deviation of the pipette's longitudinal axis from the vertical) and changes in the weight of the liquid. To achieve high accuracy, it is advantageous to calibrate the pipetting device with the flow sensor using an external, calibrated flow sensor. For liquids with viscosity and density different from water, a correction factor can be determined by the user.

Summary: A pipetting device has a receptacle for a pipette, which is intended for the aspiration and dispensing of a liquid. The pipetting device 11 comprises a receiving device 17 for a pipette, a pump 121 with steplessly configurable pump output, and at least one valve for controlling the pumping direction in such a way that, during operation, the pump 121 generates positive pressure or negative pressure in the receiving device 17 depending on the position of the valve. Furthermore, the pipetting device 11 comprises at least one actuator button 14a for switching on the pump 121 and for controlling the valve. The pipetting device 11 is characterized in that the actuator button 14a, in conjunction with a sensor connected to a control unit, is designed to generate a signal that can assume a plurality of values between zero and a specific maximum level, wherein the control unit steplessly controls the pump output of the pump depending on the respective level assumed by the signal.

### REFERENCE LIST

11 pipetting device
12 handle
13 pipetting aid
14 control buttons
15 receiving device for pipettes
16 pipette
17 pipette holder
19 filter
21 clamping device
23 housing
25 cylinder shell
27 bottom
29 opening of the bottom
31 headpiece
33a, 33b side walls
35 bottom wall
37 top wall
39 intermediate bottom wall
40 space for receiving the pipette holder
41 recess
43 introduction opening of the pipette holder
45 protrusion in side walls 33a, 33b
47 retaining flanges
49 clamping jaws
51 central piece
53 wings
55 webs
57 spring
59 edge
60 guide strip
61 walls
62 guide groove
63 slanted surface of the clamping jaws
65 spacer
67 L-shaped webs
69 leg
71 insertion compartments
73 housing cover
75 webs
77 push buttons
79 bolt
81 leg
83 side housing wall
85 undercut
87 hook
89 angular piece
91 filter housing
93 center axis
95 pipette receiving channel
97 conduit section
99 first connection piece
101 longitudinal axis
103 space between the false bottom wall and the housing bottom
105 pipette neck
107 sensor
109 second connection piece
111 connecting piece
121 pump
123, 127, 131, 137 conduits
125, 129 multi-way valves
133,135 one-way valves
139 temperature sensor
141 first pressure sensor
143 gas flow sensor
145 control unit
147 data storage
149 control conduits
151 interface
153 bypass conduit
155 second pressure sensor
157 acceleration sensor
159 base of the control buttons
161 printed circuit board
163 spring
165 flexible shaft
167 strain gauges
169 battery
171 switch

1.-15. (canceled)

16. A pipetting device for receiving a pipette, wherein the pipette is intended for the aspiration and dispensing of a liquid, comprising:
a receiving device for receiving a pipette,
a pump that is pneumatically connected to the receiving device via a conduit,
at least one valve arranged in the conduit for interrupting the volume flow from the receiving device to the pump,
a control unit connected to the pump, and
at least one actuator button, also connected to the control unit, for controlling the pump and the valve, wherein
the pipetting device has a sensor arrangement configured to detect a gas flow in the conduit, wherein the pipetting device is configured to steplessly regulate a pump output of the pump by means of an actuator button signal generated by variable button pressure of the actuator button and the detection of the gas flow.

17. The pipetting device according to claim 16, wherein the actuator button is connected to a pressure-sensitive sensor and the actuator button signal changes with the pressure applied.

18. The pipetting device according to claim 16, wherein the actuator button is movable and the value of the actuator button signal varies depending on its button stroke.

19. The pipetting device according to claim 16, wherein the actuator button signal is an analog signal, and the pump output of the pump is coupled to the level of the analog signal, in particular wherein the level of the analog signal is greater the greater the movement path of the actuator button.

20. The pipetting device according to claim 16, wherein the actuator button is preloaded into the rest position by a compression spring, wherein the compression spring is supported on a flexible shaft, wherein the flexible shaft is connected to a strain gauge.

21. The pipetting device according to claim 16, wherein the conduit is connected to a bypass conduit and the sensor arrangement is configured to provide detection of gas flow in the conduit via detection of gas flow in the bypass conduit.

22. The pipetting device according to claim 19, wherein a gas flow in the bypass conduit is coupled to the level of the analog signal.

23. The pipetting device according to claim 19, wherein the pipetting device has a gas flow sensor in the conduit between the receiving device and the pump, which is configured to measure the mass or volume flow in the conduit, wherein the pipetting device is configured to regulate the pump output depending on the mass or volume flow in this conduit.

24. The pipetting device according to claim 23, wherein the gas flow sensor measures the mass or volume flow in the bypass conduit.

25. The pipetting device according to claim 16, wherein the pump is a membrane pump, in particular wherein the pump is a piezoelectric pump.

26. The pipetting device according to claim 16, wherein the pipetting device has a further actuator button, the actuation of which generates a digital signal, wherein this signal causes a release of a negative pressure or a positive pressure in the pipetting device, wherein the pipetting device is configured such that the release of the negative pressure is temporary and the negative pressure is regenerated after a predefined period of time or after a predefined volume or mass has flowed through the conduit.

27. A method for operating a pipetting device designed to receive a pipette, wherein a pump of the pipetting device with steplessly configurable pump output is steplessly regulated by means of variable button pressure on an actuator button and detection of a gas flow in a conduit between a receiving device for receiving the pipette and the pump.

28. The method according to claim 27, wherein a mass or volume flow is detected in the conduit and the pump output is regulated depending on this.

29. The method according to claim 28, wherein pressure in the conduit is also measured to regulate the pump output.

30. The method according to claim 28, wherein an aspirated or dispensed amount of liquid is calculated depending on the detected mass or volume flow and, in particular, depending on the measured pressure, wherein the deviation of the pipette longitudinal axis from the vertical is additionally taken into account when calculating the aspirated or dispensed amount of liquid.
